(19) United States
(12) Patent Application Publication
(10) Pub. No.: US 2011/0139535 A1
(43) Pub. Date: Jun. 16, 2011

(54) Scooter

(76) Inventor: Yi-Ling Jhao, Chia Yi City (TW)

(21) Appl. No.: 12/654,181

(22) Filed: Dec. 14, 2009

(51) Int. Cl. B62D 3/02

(52) U.S. Cl. 180/400

(57) ABSTRACT

A scooter is revealed. The scooter includes a directional-control handle that is assembled over the top of a rotating shaft that moves along with rotation of front wheels. The directional-control handle includes at least three operation handles-a left-side operation handle, a right-side operation handle and a rear-side operation handle. Moreover, a control rod that connects with a horizontally projecting rotation axis of a controller is disposed under the directional-control handle. Thus the control rod can be pulled up or pressed down on the two ends thereof around the rotation axis. Furthermore, a fine adjustment member for adjusting angle is arranged between the directional-control handle and the rotating shaft so as to adjust the angle between the directional-control handle and the rotating shaft. Thereby the scooter is with good control performance and providing better comfort when the user drives the scooter.

### BACKGROUND OF THE INVENTION

1. Fields of the invention

The present invention relates to a scooter, especially to a scooter that provides good control performance and greater comfort to users.

2. Descriptions of Related Art

Generally sick and old people walk so slow that they need to use canes, walkers or wheelchairs once they want to make a long distance move. But such mobility aids are operated by manual labor and this not only requires a lots of energy but also with speed limits. Thus various electric scooters that convert electricity to mechanical power for helping disabled in their mobility requirements have been developed.

A common electric scooter includes a direction control lever that is connected and fixed on top of a rotating shaft moving along with rotation of front wheels. Thus the direction control lever and the rotating shaft are perpendicular to each other to form a T shape. That means the direction control lever extends from top end of the rotation axis to two sides to form a grip region held by user's hands. However, users can't adjust their posture or change holding positions on the direction control lever with such design while riding the scooter. When the scooter make turns, the larger the rotation angle is, the longer is the distance between user's body and the holding position. Since different people have different arm length and some even with congenital or acquired defects of their arms, some people may be unable to hold two ends of the direction control lever by both of the hands while making turns. This endangers the safety of users and the rotation angle of the scooter is limited.

Moreover, most of rotation axes of controllers that control movement of the scooters available now are arranged vertically. Thus a control rod connected with the rotation shaft is pulled forward and backward around the rotation axis. After a long drive, such operation mode of the control rod causes fatigue and the thumb gets affected. This interferes with applying force when the scooters make turns and leads to unfavorable operation.

Furthermore, although there is an angle adjustment member disposed between the rotating shaft and the direction control lever, a retractor is required to be added between the rotating shaft and the direction control lever for adjusting a panel to move upward or downward. This leads to complicated structure, increased cost, and trouble in maintenance.

### SUMMARY OF THE INVENTION

Therefore it is a primary object of the present invention to provide a scooter in which a directional control handle of the scooter is with good control performance and different users can adjust and hold the directional control handle in a comfortable posture according to their own demands.

It is another object of the present invention to provide a scooter in which a control rod is operated by the user according to ergonomic principles so as to reduce user's fatigue. And the control rod will not interfere with the operation of the directional control handle.

It is a further object of the present invention to provide a scooter in which an angle of the directional control handle is adjustable so that users can adjust the directional control handle according to their own gripping angle with greatest comfort.

In order to achieve above objects, a directional-control handle is assembled and fixed over the top of a rotating shaft that moves along with rotation of front wheels. The directional-control handle includes at least three operation handles-a left-side operation handle, a right-side operation handle and a rear-side operation handle. Thus users can grip the directional control handle with comfort and ease while driving the scooter or change the holding position of the hand on the left-side operation handle, the right-side operation handle, or the rear-side operation handle according to the arm length while making turns. Thereby the scooter offers users greater comfort, less fatigue and better control performance.

In order to achieve above objects, a scooter of the present invention further includes a control rod disposed under the directional-control handle. The control rod connects with a horizontally projecting rotation axis of a controller so that the control rod can be pulled up or pressed down on the two ends thereof around the rotation axis. Thus when the user holds the directional-control handle, he can also pull the control rod by the thumb or other four fingers so as to make the scooter move forward or backward. This is an ergonomic approach with enhanced comfort and reduced fatigue. Especially when the scooter turns, the hand that pulls the control rod can temporarily leave the directional-control handle but continue pulling the control rod while the user can use the other hand to rotate the directional-control handle. There is no impact on the operation.

The control rod is divided into a long rod part and a short rod part by the rotation axis. The long rod part and the short rod part respectively control forward and backward movement of the scooter. There is a certain angle between the long rod part and the short rod part.

In order to achieve above objects, a scooter of the present invention includes a fine adjustment member for adjusting angle disposed between the directional-control handle and the rotating shaft so as to adjust the angle between the directional-control handle and the rotating shaft. Thus the user can adjust the directional-control handle to find out an optimal angle for gripping according to his height. And drivers with various heights can figure out the most comfortable way of holding by their hands.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a scooter according to the present invention;

FIG. 2 is a partial explosive view of an embodiment of a scooter according to the present invention;

FIG. 3 is a schematic drawing showing a side view of a partial assembly of an embodiment according to the present invention;

FIG. 4 is a schematic drawing showing a front view of a partial assembly of an embodiment according to the present invention;

FIG. 5 is a side view showing operation of a long rod part of a control rod according to the present invention;

FIG. 6 is a side view showing operation of a short rod part of a control rod according to the present invention;

FIG. 7 is a schematic drawing showing angle adjustment of a directional control handle of an embodiment according to the present invention;

FIG. 8 is another schematic drawing showing angle adjustment of a directional control handle of an embodiment according to the present invention.

### DETAILED DESCRIPTION OF THE PREFERRED EMBODIMENT

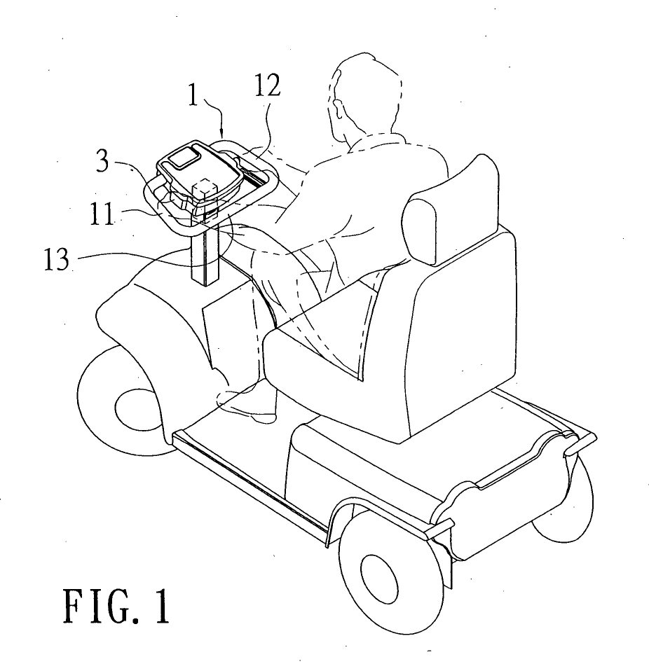

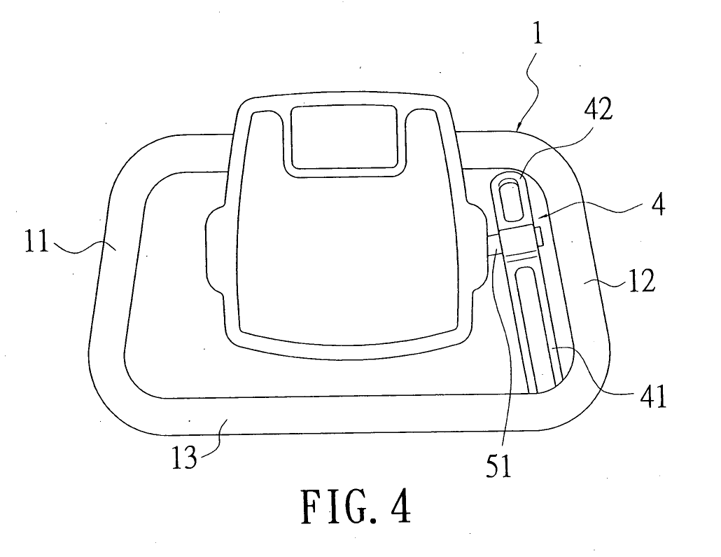

Refer from FIG. 1 to FIG. 4, a scooter of the present invention is disposed with a directional-control handle 1 that is assembled and fixed over the top of a rotating shaft 2. The rotating shaft 2 moves along with rotation of front wheels. The directional-control handle 1 consists of at least three operation handles-a left-side operation handle 11, a right-side operation handle 12 and a rear-side operation handle 13. The left-side operation handle 11 and the right-side operation handle 12 are connected with each other by the rear-side operation handle 13 therebehind. Thus the directional-control handle 1 formed by the left-side operation handle 11, the right-side operation handle 12 and the rear-side operation handle 13 is a continuous structure.

Users can hold the directional control handle 1 in a comfortable posture while driving the scooter or change the holding position of the hand on the left-side operation handle 11, the right-side operation handle 12, or the rear-side operation handle 13 according to the user's arm length while making a turn. This result in less fatigue for the users and provide better control performance of the scooter.

Moreover, the top of the rotating shaft 2 is connected with a base 3 whose two sides are respectively connected with one end of the left-side operation handle 11, and one end of the right-side operation handle 12 that are opposite to an end connected with the rear-side operation handle 13. Thus while operating the directional-control handle 1, the rotating shaft 2 also moves through the connection with the base 3 so as to drive the front wheels for changing directions.

Furthermore, the rotating shaft 2 is composed of an upper shaft section 21, a lower shaft section 22 and a universal joint 23. The upper shaft section 21 and the lower shaft section 22 are connected with each other by the universal joint 23. Thus even there is a certain rotating angle between the upper shaft section 21 and the lower shaft section 22, the upper shaft section 21 can still drive the lower shaft section 22 to move.

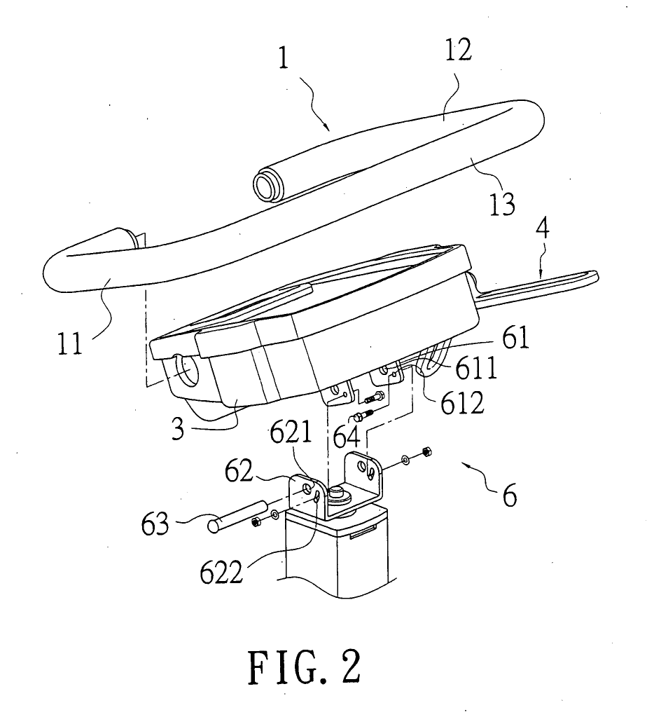

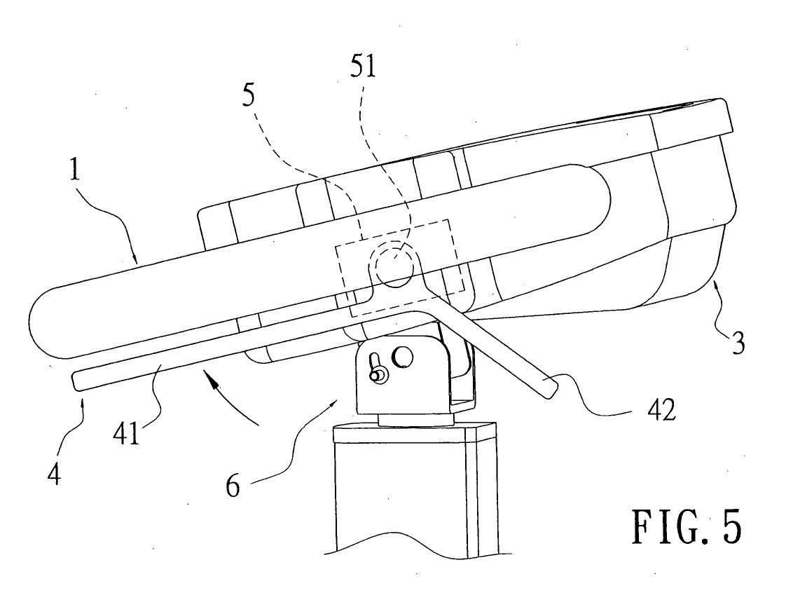

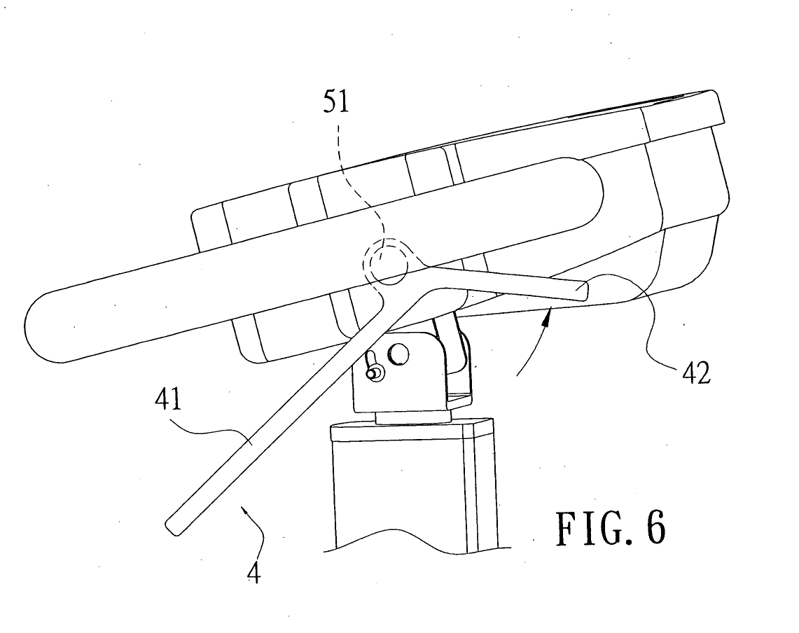

Refer to FIG. 1, FIG. 2, FIG. 5 and FIG. 6, a control rod 4 is disposed under at least one side of the directional-control handle 1. And a controller 5 having a driving circuitry that controls movement of the scooter is arranged at the base 3, corresponding to the control rod 4. The controller 5 includes a rotation axis 51 that extends and projects along a horizontal direction and connects with the control rod 4. Thus the control rod 4 can be pulled up or pressed down on the two ends thereof around the rotation axis 51 and further turning on or turning off the driving circuitry. Thereby when the user holds the directional-control handle 1, he can also pull the control rod 4 by the thumb or other four fingers so as to make the scooter move forward or backward. This movement is based on ergonomic principles for enhanced comfort and reduced fatigue. Especially when the scooter turns, the hand that pulls the control rod 4 can temporarily leave the directional-control handle 1 but continue pulling the control rod 4 while the user can use the other hand to rotate the directional-control handle 1. There is no trouble or inconvenience in the operation.

Furthermore, the control rod 4 is divided into a long rod part 41 and a short rod part 42 by the rotation axis 51. Once the long rod part 41 or the short rod part 42 is pulled, the scooter is controlled to move forward or backward through the controller 5 that moves along therewith. And there is a certain angle between the long rod part 41 and the short rod part 42.

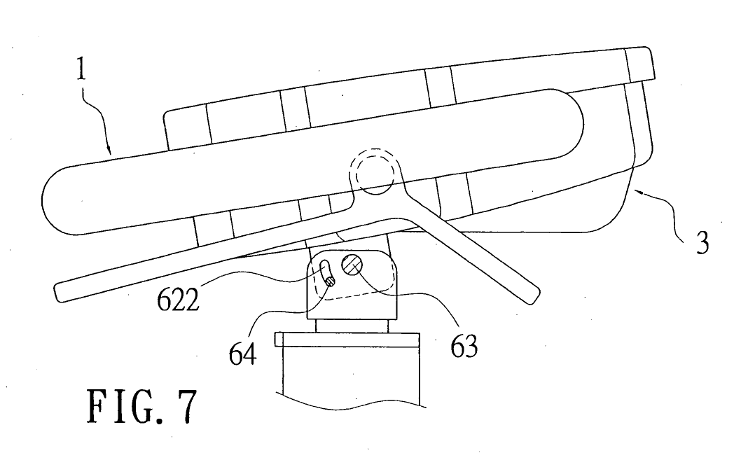

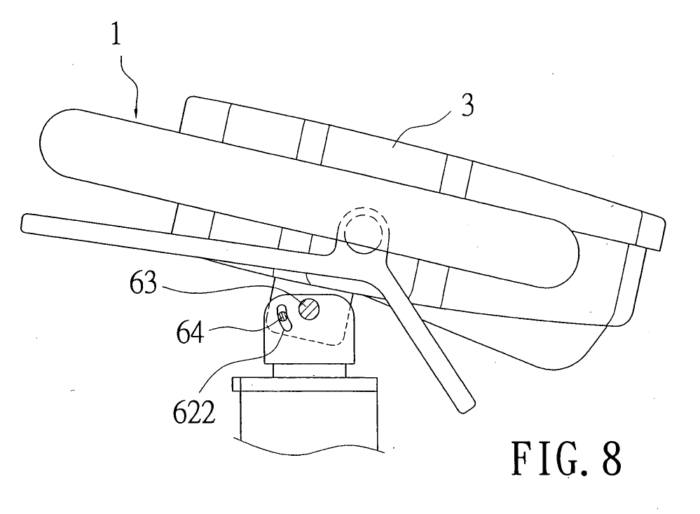

Moreover, a fine adjustment member for adjusting angle 6 is disposed between the base 3 and the rotating shaft 2, as shown from FIG. 1 to FIG. 3, FIG. 7 and FIG. 8. The angle between the directional-control handle 1 and the rotating shaft 2 is adjusted by the fine adjustment member for adjusting angle 6 so that the user can adjust the directional-control handle 1 to find out an optimal angle according to his/her height. And drivers with various heights can figure out the most comfortable way of holding by their hands.

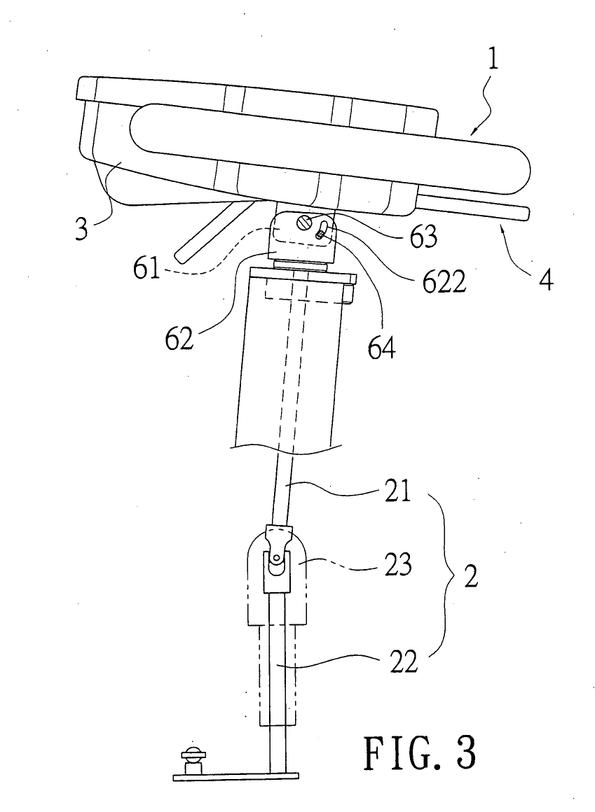

Refer to FIG. 3, the fine adjustment member for adjusting angle 6 consists of a first lug part 61 disposed on the base 3, a second lug part 62 arranged at the rotating shaft 2, a shaft assembly 63 and an adjustment assembly 64. The first lug part 61 is mounted with a bore 611 and an insertion hole 612 beside the bore 611 while the second lug part 62 is arranged with a bore 621 and an adjustment hole 622 beside the bore 621. The shaft assembly 63 inserts through the bores 611, 612 of the first lug part 61 and of the second lug part 62 so that the first lug part 61 and the second lug part 62 are pivoted. As to the adjustment assembly 64, it inserts through the insertion hole 612 of the first lug part 61 and the adjustment hole 622 of the second lug part 62. Along with the change of the position of the adjustment assembly 64 fixed in the adjustment hole 622, the angle of the directional-control handle 1 fixed on the base 3 can be changed. Thus users can adjust the directional-control handle 1 to find out the optimal angle for holding according to their heights. The adjustment hole 622 is an arc-shaped hole.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A scooter comprising: a directional-control handle disposed and fixed over a top of a rotating shaft that moves along with rotation of front wheels,
a control rod connecting with a horizontally projecting rotation axis of a controller and disposed under the directional-control handle, and a fine adjustment member for adjusting angle arranged between the directional-control handle and the rotating shaft;
wherein the directional-control handle includes at least a left-side operation handle, a right-side operation handle and a rear-side operation handle; the left-side operation handle and the right-side operation handle are connected with each other by the rear-side operation handle therebehind so as to form a continuous structure with the three operation handles; the control rod is pulled up or pressed down on the two ends thereof around the rotation axis; the fine adjustment member for adjusting angle is used to adjust an angle between the directional-control handle and the rotating shaft.

2. The device as claimed in claim 1, wherein a base is connected with the top of the rotating shaft and two sides of the base are respectively connected with one end of the left-side operation handle, and one end of the right-side operation handle, respectively opposite to an end connected with the rear-side operation handle.

3. The device as claimed in claim 2, wherein the rotating shaft includes an upper shaft section, a lower shaft section and a universal joint that connects the upper shaft section with the lower shaft section.

4. The device as claimed in claim 1, wherein the control rod includes a long rod part and a short rod part respectively located on two sides of the rotation axis.

5. The device as claimed in claim 4, wherein an angle is formed between the long rod part and the short rod part.

6. The device as claimed in claim 1, wherein the fine adjustment member for adjusting angle includes a first lug part disposed on the base, a second lug part arranged at the rotating shaft, a shaft assembly and an adjustment assembly; the first lug part is mounted with a bore and an insertion hole beside the bore while the second lug part is arranged with a bore and an adjustment hole beside the bore; the shaft assembly inserts through the bores of the first lug part and the second lug part so that the first lug part and the second lug part are pivoted; the adjustment assembly inserts through the insertion hole of the first lug part and the adjustment hole of the second lug part.

7. The device as claimed in claim 6, wherein the adjustment hole is an arc-shaped hole.

8. The device as claimed in claim 1, wherein the rotating shaft includes an upper shaft section, a lower shaft section and a universal joint that connects the upper shaft section with the lower shaft section.
